(19) United States
(12) Patent Application Publication
(10) Pub. No.: US 2023/0408939 A1
(43) Pub. Date: Dec. 21, 2023

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: MICHIYO SEKIYA, Shizuoka (JP); AKIHIRO MARUYAMA, Shizuoka (JP); MASASHI NISHI, Kanagawa (JP); NANAMI KATO, Shizuoka (JP)

(21) Appl. No.: 18/332,305

(22) Filed: Jun. 9, 2023

(30) Foreign Application Priority Data
Jun. 15, 2022 (JP) 2022-096641

(51) Int. Cl. G03G 5/09; G03G 15/00

(52) U.S. Cl. CPC G03G 5/09; G03G 15/75

(57) ABSTRACT

An electrophotographic photosensitive member capable of suppressing a pattern memory. Specifically, an electrophotographic photosensitive member including: a support; an undercoat layer formed on the support; and a photosensitive layer formed on the undercoat layer, wherein the undercoat layer contains a polymerization product of a composition containing: an electron-transporting substance represented by the formula (1); and a crosslinking agent, and wherein the crosslinking agent has a functional group capable of being bonded to at least one polymerizable functional group of the electron-transporting substance.

### BACKGROUND OF THE INVENTION

### Field of the Invention

The present disclosure relates to an electrophotographic photosensitive member, and a process cartridge and an electrophotographic apparatus each including the electrophotographic photosensitive member.

### Description of the Related Art

In an electrophotographic photosensitive member to be used for an electrophotographic process, there is known a technology involving arranging an undercoat layer containing an electron-transporting substance between a support and a photosensitive layer for the purpose of suppressing charge injection from the support side to the photosensitive layer side to suppress the occurrence of an image defect such as a black spot.

In each of Japanese Patent Application Laid-Open No. 2015-092227 and Japanese Patent Application Laid-Open No. 2020-020919, there is a description of an electron-transporting layer containing a cured product of a composition containing an electron-transporting substance having a polymerizable functional group, a crosslinking agent, and a resin.

In recent years, mass printing and high-speed printing have been required in the electrophotographic process, and the electrophotographic photosensitive member has been required to have high sensitivity and durability. Accordingly, as a charge-generating substance, one having higher sensitivity has been used. However, as a result of the sensitivity of the charge-generating substance being increased to increase a charge generation amount, there has arisen a disadvantage in that, when the same image is output in a large number within a short period of time, charge at an exposed portion is liable to be retained in the photosensitive layer.

An investigation made by the inventors has found that the electrophotographic photosensitive member described in each of Japanese Patent Application Laid-Open No. 2015-092227 and Japanese Patent Application Laid-Open No. 2020-020919 does not have a sufficient electron-transporting ability in long-term use at high speed, leading to the occurrence of an image defect called a pattern memory in some cases. The “pattern memory” refers to the following phenomenon: when an image 301 of FIG. 1, which includes vertical lines 306, is continuously output in a large number and then a solid black image 302 is output, the output solid black image is an image 304 including vertical lines 307 owing to a repetition hysteresis of the vertical lines 306 of the image 301 of FIG. 1. When the image 301 of FIG. 1 is continuously output in a large number and then a halftone image 303 is output, the output halftone image is an image 305 including vertical lines 308 owing to the repetition hysteresis of the vertical lines 306 of the image 301 of FIG. 1, as in the case of the solid black image.

### SUMMARY OF THE INVENTION

Accordingly, an aspect of the present disclosure is to provide an electrophotographic photosensitive member capable of suppressing a pattern memory.

The above-mentioned aspect is achieved by the present disclosure described below. That is, according to the present disclosure, there is provided an electrophotographic photosensitive member including: a support; an undercoat layer formed on the support; and a photosensitive layer formed on the undercoat layer, wherein the undercoat layer contains a polymerization product of a composition containing: an electron-transporting substance represented by the following formula (1); and a crosslinking agent, and wherein the crosslinking agent has a functional group capable of being bonded to at least one polymerizable functional group of the electron-transporting substance:

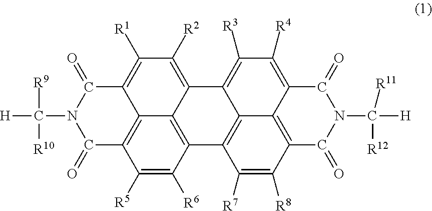

in the formula (1), R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group, and R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group, provided that at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.

Further features of the present disclosure will become apparent from the following description of exemplary embodiments with reference to the attached drawings.

### BRIEF DESCRIPTION OF THE DRAWINGS

FIG. 1 is a view for illustrating an image defect in long-term use of an electrophotographic photosensitive member at high speed.

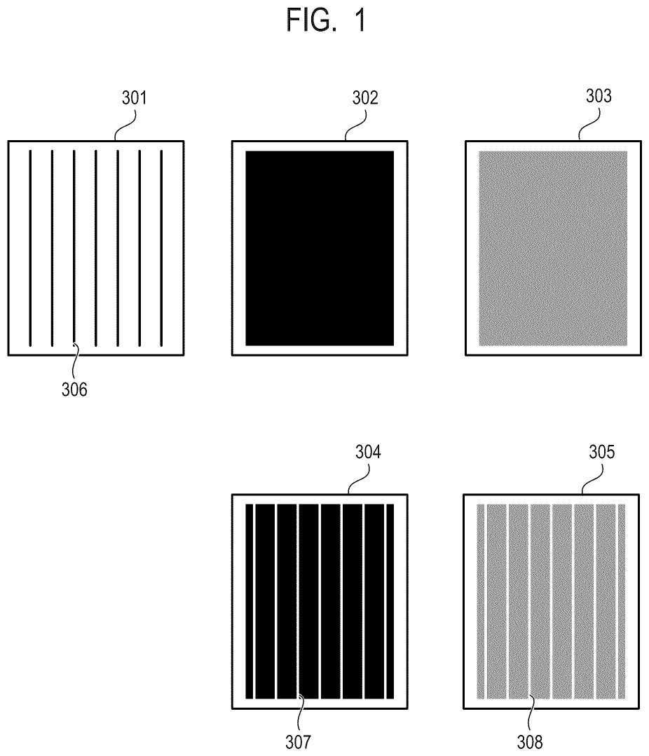

FIG. 2 shows a 1H-NMR spectrum of an electron-transporting substance A1-1.

FIG. 3 is a view for illustrating a schematic configuration in an example of an electrophotographic apparatus including a process cartridge including an electrophotographic photosensitive member.

### DESCRIPTION OF THE EMBODIMENTS

The present disclosure is described in detail below by way of exemplary embodiments.

The inventors conceived of incorporating a highly π-conjugated perylene imide at a high concentration for the purpose of increasing the mobility of an electron-transporting material with a view to further ameliorating a pattern memory. However, even when a film was formed with the perylene imide at a high concentration, the mobility was not sufficiently increased in some cases.

Originally, the perylene imide assumes a rigid planar structure, and hence is liable to stack. Accordingly, in a photosensitive layer, when the ratio of the electron-transporting material is high, a stack due to the planar structure of perylene is liable to be formed. Accordingly, it was presumed that, when a film was formed with the perylene imide at a high concentration, a non-uniform film was obtained, which caused the inhibition of an improvement in mobility of the electron-transporting material in the film as a whole.

In view of the foregoing, the following was aimed at: as is generally known, the use of perylene having substituents at bay positions makes the stacking less liable to occur. An example of the structure of the perylene having substituents at bay positions is shown in the formula (2). In the formula (2), R¹⁰² to R¹⁰⁸, R²⁰¹, and R²⁰² each represent a substituent. The “bay positions” refer to the positions of R¹⁰², R¹⁰³, R¹⁰⁶, and R¹⁰⁷ in the formula (2). It was found that the use of the perylene having substituents at the bay positions did not necessarily provide the stack-suppressing effect depending on the structures of R²⁰¹ and R²⁰² in the formula (2).

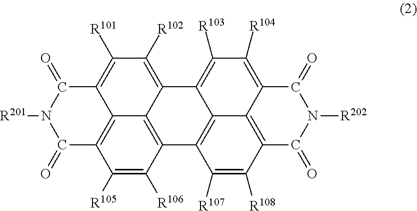

As a result of further investigations, it was found that, when R²⁰¹ and R²⁰² did not assume branched structures, the stack-suppressing effect of the substituents at the bay positions was lost. This was conceivably because, although the planar structure of perylene was twisted by the substituents at the bay positions, when R²⁰¹ and R²⁰² did not assume branched structures, the twisting of the planar structure of perylene was low, and hence the stacking occurred.

In view of the foregoing, in the case of using the perylene having substituents at the bay positions, when a branched structure was adopted for each of R²⁰¹ and R²⁰², the twisting of the planar structure was able to be maintained to enable molecules to be appropriately distanced from each other without being stacked even at a high concentration. As a result, a uniform film was formed, and such mobility of the electron-transporting material that the effect of the increased concentration was sufficiently exhibited was able to be achieved.

The inventors have made extensive investigations based on the above-mentioned mechanism, and as a result, have achieved the suppression of a pattern memory.

That is, the inventors have found an undercoat layer having a feature of containing a polymerization product of a composition containing an electron-transporting substance represented by the following formula (1) and a crosslinking agent.

[Electrophotographic Photosensitive Member]

An electrophotographic photosensitive member of the present disclosure includes a support, an undercoat layer, and a photosensitive layer.

As a method of producing the electrophotographic photosensitive member of the present disclosure, there is given a method involving preparing coating liquids for respective layers to be described later, applying the coating liquids for the respective layers in a desired order, and drying the coating liquids. In this case, as a method of applying the coating liquids, there are given, for example, dip coating, spray coating, inkjet coating, roll coating, die coating, blade coating, curtain coating, wire bar coating, and ring coating. Of those, dip coating is preferred from the viewpoints of efficiency and productivity.

The respective layers are described below.

<Support>

In the present disclosure, the electrophotographic photosensitive member includes a support. In the present disclosure, the support is preferably an electroconductive support having electroconductivity. In addition, examples of the shape of the support include a cylindrical shape, a belt shape, and a sheet shape. Of those, a cylindrical support is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. Of those, aluminum is preferred, and the support is preferably an aluminum support.

In addition, electroconductivity may be imparted to the resin or the glass through treatment involving, for example, mixing or coating the resin or the glass with an electroconductive material.

<Electroconductive Layer>

In the present disclosure, an electroconductive layer may be arranged on the support. The arrangement of the electroconductive layer can conceal flaws and unevenness in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each be of a laminated configuration having a core particle and a coating layer coating the particle. Examples of the core particle include titanium oxide, barium sulfate, and zinc oxide. The coating layer is, for example, a metal oxide such as tin oxide.

In addition, when the metal oxide is used as the electroconductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, resin particles, or a concealing agent such as titanium oxide.

The average thickness of the electroconductive layer is preferably 1 μm or more and 50 μm or less, particularly preferably 3 μm or more and 40 μm or less.

The electroconductive layer may be formed by preparing a coating liquid for an electroconductive layer containing the above-mentioned materials and a solvent, forming a coating film thereof, and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method involving using a paint shaker, a sand mill, a ball mill, or a liquid collision type high-speed disperser.

<Undercoat Layer>

In the present disclosure, an undercoat layer is arranged on the support or the electroconductive layer.

In the present disclosure, the undercoat layer is obtained by forming a coating film of a coating liquid for an undercoat layer containing an electron-transporting substance represented by the following formula (1) and a crosslinking agent, and polymerizing the coating film through drying by heating. A temperature at the time of the drying by heating is preferably a temperature of from 100° C. to 200° C.

The electron-transporting substance and the crosslinking agent are each described below.

(1) Electron-Transporting Substance

The electron-transporting substance to be used in the present disclosure is represented by the following formula (1).

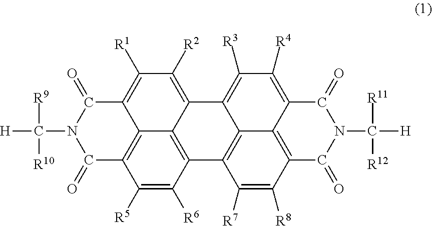

In the formula (1), R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group.

Examples of the alkyl group include a methyl group, an ethyl group, a n-propyl group, an isopropyl group, a n-butyl group, an isobutyl group, a sec-butyl group, a tert-butyl group, a n-pentyl group, an isopentyl group, a neopentyl group, a tert-pentyl group, a cyclopentyl group, a n-hexyl group, a 1-methylpentyl group, a 4-methyl-2-pentyl group, a 3,3-dimethylbutyl group, a 2-ethylbutyl group, and a cyclohexyl group.

Examples of the aryl group include a phenyl group, a biphenylyl group, and a fluorenyl group.

Examples of the substituent of the substituted alkyl group include an aryl group, a halogen atom, a nitro group, a cyano group, a hydroxy group, a sulfanyl group, an amino group, an alkoxycarbonyl group, an alkoxy group, and a carboxy group.

Examples of the substituent of the substituted aryl group include a halogen atom, a nitro group, a cyano group, a hydroxy group, a sulfanyl group, an amino group, an alkyl group, a halogen-substituted alkyl group, an alkoxy group, and a carboxy group.

For the reasons of difficulty of stacking due to the planar structure of the perylene imide and an influence on the mobility in the formation of a uniform film state, a halogen atom or a substituted or unsubstituted alkyl group having 12 or less carbon atoms is preferred.

In addition, for the same reasons, a structure in which R² and R⁷ are identical to each other is preferred.

In the formula (1), R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group.

For the reason of the influence on the mobility at the time of the formation of a uniform film state, such a structure that, in the formula (1), —CHR⁹R¹⁰ is different from —CHR¹¹R¹² is preferred.

In the formula (1), at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.

In order to form a uniform film to achieve sufficiently high mobility of the electron-transporting material, a structure in which R⁹ represents an alkyl group having a polymerizable functional group and the alkyl group having a polymerizable functional group has 2 or less carbon atoms is preferred. When the number of carbon atoms was more than 3, sufficient mobility was not obtained in some cases.

The polymerizable functional group is a hydroxy group, a thiol group, an amino group, or a carboxy group. Of those, a hydroxy group is preferred for forming a uniform film to achieve sufficiently high mobility of the electron-transporting material.

Those compounds may be mainly synthesized by a method described in Japanese Patent Application Laid-Open No. 2014-029479.

Specific examples of the compound represented by the general formula (1) are shown in Table 1-1 to Table 2-4 below.

TABLE 1-1

| | R¹ | R² | R³ | R⁴ | R⁵ | R⁶ | R⁷ |
|---|---|---|---|---|---|---|---|
| A01 | H | Br | H | H | H | H | Br |
| A02 | H | Cl | H | H | H | H | Cl |
| A03 | H | 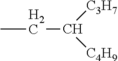 | H | H | H | H | 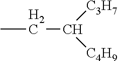 |
| A04 | H | 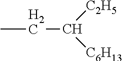 | H | H | H | H | 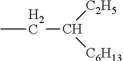 |
| A05 | H | Cl | Cl | H | H | Cl | Cl |
| A06 | H | CN | H | H | H | H | CN |
| A07 | H | NO₂ | H | H | H | H | NO₂ |
| A08 | H | 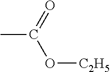 | H | H | H | H | 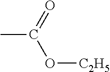 |
| A09 | H | 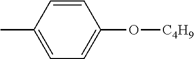 | H | H | H | H | 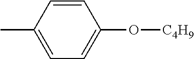 |
| A10 | H | 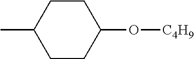 | H | H | H | H | 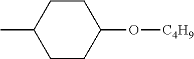 |

TABLE 1-2

| | R⁸ | R⁹ | R¹⁰ | R¹¹ | R¹² |
|---|---|---|---|---|---|
| A01 | H | 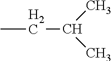 | —CH₂OH | 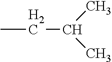 | —CH₂OH |
| A02 | H | 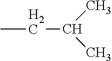 | —CH₂OH | 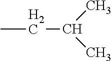 | —CH₂OH |
| A03 | H | 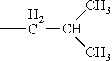 | —CH₂OH | 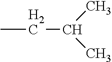 | —CH₂OH |
| A04 | H | 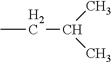 | —CH₂OH | 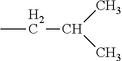 | —CH₂OH |
| A05 | H | 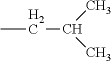 | —CH₂OH | 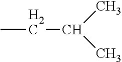 | —CH₂OH |
| A06 | H | 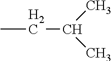 | —CH₂OH | 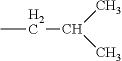 | —CH₂OH |
| A07 | H | 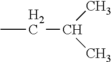 | —CH₂OH | 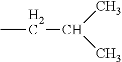 | —CH₂OH |
| A08 | H | 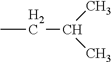 | —CH₂OH | 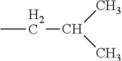 | —CH₂OH |
| A09 | H | 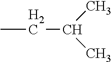 | —CH₂OH | 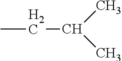 | —CH₂OH |
| A10 | H | 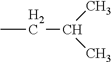 | —CH₂OH | 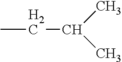 | —CH₂OH |

TABLE 1-3

| | R¹ | R² | R³ | R⁴ | R⁵ | R⁶ | R⁷ |
|---|---|---|---|---|---|---|---|
| A11 | H | Br | H | H | H | H | H |
| A12 | H | Cl | H | H | H | H | H |
| A13 | H | 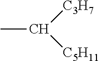 | H | H | H | H | H |
| A14 | H | Br | H | H | H | H | Br |
| A15 | H | Br | H | H | H | H | Br |
| A16 | H | Br | H | H | H | H | Br |
| A17 | H | Br | H | H | H | H | Br |
| A18 | H | Cl | Cl | H | H | Cl | Cl |
| A19 | H | Cl | Cl | H | H | Cl | Cl |
| A20 | H | 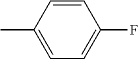 | H | H | H | H | 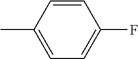 |

TABLE 1-4

| | R⁸ | R⁹ | R¹⁰ | R¹¹ | R¹² |
|---|---|---|---|---|---|
| A11 | H | 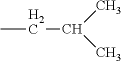 | —CH₂OH | 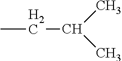 | —CH₂OH |
| A12 | H | 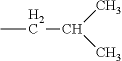 | —CH₂OH | 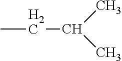 | —CH₂OH |
| A13 | H | 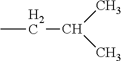 | —CH₂OH | 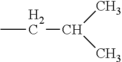 | —CH₂OH |
| A14 | H | —CH₂OH | —CH₂OH | 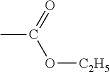 | 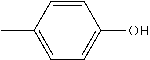 |
| A15 | H | 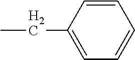 | —CH₂OH | 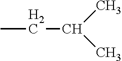 | —CH₂OH |
| A16 | H | 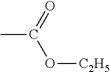 | 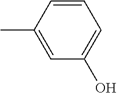 | 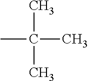 | —CH₂OH |
| A17 | H | 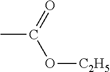 | 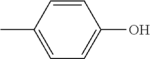 | —C₄H₉ | —CH₂OH |
| A18 | H | 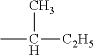 | —CH₂OH | 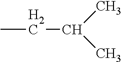 | —CH₂OH |
| A19 | H | 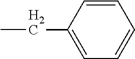 | —CH₂OH | —C₅H₁₁ | —C₃H₇ |
| A20 | H | —CH₂OH | —CH₂OH | 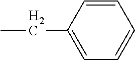 | —CH₃ |

TABLE 2-1

| | R¹ | R² | R³ | R⁴ | R⁵ | R⁶ | R⁷ |
|---|---|---|---|---|---|---|---|
| A21 | H | Br | H | H | H | H | Br |
| A22 | H | Cl | H | H | H | H | Cl |
| A23 | H | NO₂ | H | H | H | H | NO₂ |
| A24 | H | Cl | Cl | H | H | Cl | Cl |
| A25 | H | Cl | Cl | H | H | Cl | Cl |
| A26 | H | Br | H | H | H | H | Br |
| A27 | H | Br | H | H | H | H | Br |
| A28 | H | Br | H | H | H | H | Br |
| A29 | H | Br | H | H | H | H | Br |
| A30 | H | Br | H | H | H | H | Br |

TABLE 2-2

| | R⁸ | R⁹ | R¹⁰ | R¹¹ | R¹² |
|---|---|---|---|---|---|
| A21 | H | 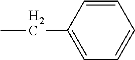 | —CH₂OH | 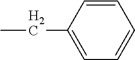 | —CH₂OH |
| A22 | H | 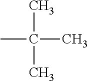 | —CH₂OH | 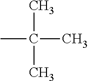 | —CH₂OH |
| A23 | H | —C₃H₇ | —CH₂OH | —C₃H₇ | —CH₂OH |
| A24 | H | 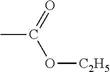 | 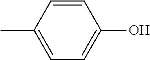 | 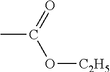 | 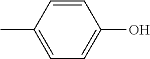 |
| A25 | H | 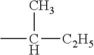 | —CH₂OH | 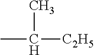 | —CH₂OH |
| A26 | H | 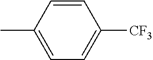 | —C₅H₁₀—OH | 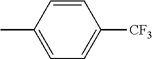 | —C₅H₁₀—OH |
| A27 | H | 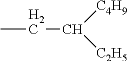 | —C₂H₄OH | 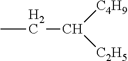 | —C₂H₄OH |
| A28 | H | 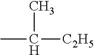 | —OH | 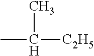 | —OH |
| A29 | H | 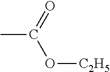 | —C₂H₄OH | 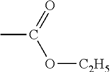 | —C₂H₄OH |
| A30 | H | 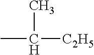 | —C₃H₆OH | 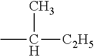 | —C₃H₆OH |

TABLE 2-3

| | R¹ | R² | R³ | R⁴ | R⁵ | R⁶ | R⁷ |
|---|---|---|---|---|---|---|---|
| A31 | H | Br | H | H | H | H | Br |
| A32 | H | Cl | Cl | H | H | Cl | Cl |
| A33 | H | Cl | Cl | H | H | Cl | Cl |
| A34 | H | Br | H | H | H | H | Br |
| A35 | H | Br | H | H | H | H | Br |
| A36 | H | Br | H | H | H | H | Br |
| A37 | H | Br | H | H | H | H | Br |
| A38 | H | 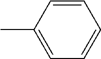 | H | H | H | H | 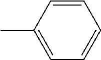 |
| A39 | H | 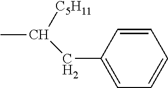 | H | H | H | H | 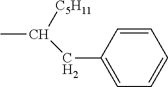 |
| A40 | H | Cl | Cl | H | H | Cl | Cl |
| A41 | H | Br | H | H | H | H | Br |
| A42 | H | Cl | H | H | H | H | Cl |

TABLE 2-4

| | R⁸ | R⁹ | R¹⁰ | R¹¹ | R¹² |
|---|---|---|---|---|---|
| A31 | H | 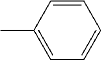 | —CH₂OH | 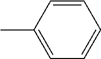 | —CH₂OH |
| A32 | H | —C₃H₇ | 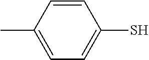 | —C₃H₇ | 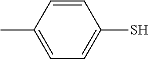 |
| A33 | H | —C₂H₅ | —CH₂—COOH | —C₂H₅ | —CH₂—COOH |
| A34 | H | —C₂H₅ | 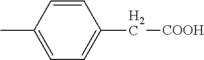 | —C₂H₅ | 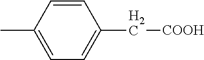 |
| A35 | H | 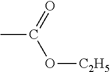 | —CH₂SH | 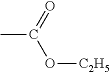 | —CH₂SH |
| A36 | H | 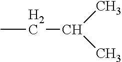 | —CH₂NH₂ | 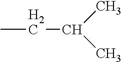 | —CH₂NH₂ |
| A37 | H | —C₃H₇ | 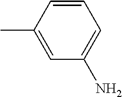 | —C₃H₇ | 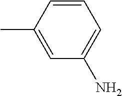 |
| A38 | H | 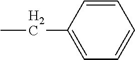 | —C₂H₄OH | 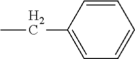 | —C₂H₄OH |
| A39 | H | 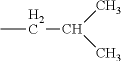 | —CH₂OH | 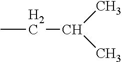 | —CH₂OH |
| A40 | H | 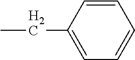 | —CH₂OH | 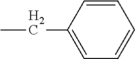 | —CH₂OH |
| A41 | H | —C₂H₅ | 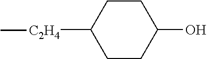 | 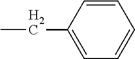 | —CH₂OH |
| A42 | H | 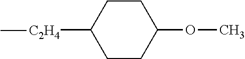 | —CH₂OH | 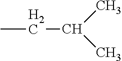 | —CH₂OH |

(2) Crosslinking Agent

In the present disclosure, the crosslinking agent has a functional group capable of being bonded to at least one polymerizable functional group of the electron-transporting substance represented by the formula (1). Any material known as a crosslinking agent may be used within this range. Specific examples thereof include compounds described in “Crosslinking Agent Handbook” edited by Shinzo Yamashita and Tosuke Kaneko and published by Taiseisha Ltd. (1981).

The crosslinking agent is preferably an isocyanate compound having an isocyanate group or a blocked isocyanate group, or an amine compound having an N-methylol group or an alkyl-etherified N-methylol group. Of those, an isocyanate compound having 2 to 6 isocyanate groups or blocked isocyanate groups is preferred.

Examples of the isocyanate compound include isocyanate compounds shown below, but the present disclosure is not limited thereto. In addition, the isocyanate compounds may be used in combination thereof.

Examples thereof include triisocyanatobenzene, triisocyanatomethylbenzene, triphenylmethane triisocyanate, lysine triisocyanate, diisocyanates, such as tolylene diisocyanate, hexamethylene diisocyanate, dicyclohexylmethane diisocyanate, naphthalene diisocyanate, diphenylmethane diisocyanate, isophorone diisocyanate, xylylene diisocyanate, 2,2,4-trimethylhexamethylene diisocyanate, methyl-2,6-diisocyanate hexanoate, and norbornane diisocyanate, isocyanurate modified forms, biuret modified forms, and allophanate modified forms thereof, and adduct modified forms thereof with trimethylolpropane or pentaerythritol. The blocked isocyanate group is a group having the structure —NHCOX¹ (X¹ represents a protective group). X¹ represents any protective group capable of being be introduced into an isocyanate group.

As a purchasable isocyanate compound, there are given, for example, isocyanate-based crosslinking agents, such as DURANATE MFK-60B, SBA-70B, 17B-60P, SBN-70D, or SBB-70P manufactured by Asahi Kasei Chemicals Corporation, and DESMODUR BL3175 or BL3475 manufactured by Sumika Bayer Urethane Co., Ltd.

The amine compound preferably has an N-methylol group or an alkyl-etherified N-methylol group. In addition, an amine compound having a plurality of (two or more) N-methylol groups or alkyl-etherified N-methylol groups is more preferred. Examples thereof include methylolated melamine, a methylolated guanamine, a methylolated urea derivative, a methylolated ethyleneurea derivative, methylolated glycoluril, and a compound having an alkyl-etherified methylol moiety, and derivatives thereof.

As a purchasable amine compound, there are given, for example, SUPER MELAMI No. 90 (manufactured by NOF Corporation (former Nippon Oil & Fats Co., Ltd.)), SUPER BECKAMINE (trademark) TD-139-60, L-105-60, L127-60, L110-60, J-820-60, and G-821-60 (manufactured by DIC Corporation), U-VAN 2020 (Mitsui Chemicals, Inc.), Sumitex Resin M-3 (manufactured by Sumitomo Chemical Company, Limited (former Sumitomo Chemical Industry Company Limited)), NIKALAC MW-30, MW-390, and MX-750LM (manufactured by Sanwa Chemical Co., Ltd.), SUPER BECKAMINE (trademark) L-148-55, 13-535, L-145-60, and TD-126 (manufactured by DIC Corporation), NIKALAC BL-60 and BX-4000 (manufactured by Sanwa Chemical Co., Ltd.), and NIKALAC MX-280, NIKALAC MX-270, and NIKALAC MX-290 (manufactured by Sanwa Chemical Co., Ltd.).

The coating liquid for an undercoat layer in the present disclosure may contain a thermoplastic resin having a polymerizable functional group in addition to the electron-transporting substance and the crosslinking agent. Examples of the thermoplastic resin include a polyacetal resin, a polyolefin resin, a polyester resin, a polyether resin, and a polyamide resin. Examples of the polymerizable functional group include a hydroxy group, a thiol group, an amino group, a carboxy group, and a methoxy group.

Further, a thermoplastic resin having a repeating unit formed of —(CH₂—CH₂—O)ₙ— (“n” represents an integer of 2 or more and 200 or less), —(CH₂—(CH₃)CH—O)ₙ (“n” represents an integer of 2 or more and 200 or less), or —(CH₂—CH₂—O—CH₂—CH₂—S—S)ₙ— (“n” represents an integer of 2 or more and 50 or less) is preferred.

As products commercially available as the thermoplastic resins each having a polymerizable functional group, there are given, for example: polyether polyol-based resins, such as AQD-457 and AQD-473 (all of which are manufactured by Nippon Polyurethane Industry Co., Ltd.), and GP-400 and GP-700 (all of which are SANNIX manufactured by Sanyo Chemical Industries, Ltd.); polyester polyol-based resins, such as PHTHALKYD W2343 (manufactured by Hitachi Chemical Co., Ltd.), WATERSOL S-118, CD-520, BECKOLITE M-6402-50, and M-6201-40IM (all of which are manufactured by DIC Corporation), HARIDIP WH-1188 (manufactured by Harima Chemicals, Inc.), and ES3604 and ES6538 (all of which are manufactured by Japan U-Pica Company Ltd.); polyacrylic polyol-based resins, such as BURNOCK WE-300 and WE-304 (all of which are manufactured by DIC Corporation); polyvinyl alcohol-based resins such as KURARAY POVAL PVA-203 (manufactured by Kuraray Co., Ltd.); polyvinyl acetal-based resins, such as BX-1, BM-1, and KS-5 (all of which are manufactured by Sekisui Chemical Co., Ltd.); polyamide-based resins such as TORESIN FS-350 (manufactured by Nagase ChemteX Corporation); carboxy group-containing resins, such as AQUALIC (manufactured by Nippon Shokubai Co., Ltd.) and FINELEX SG2000 (manufactured by Namariichi Co., Ltd.); polyamine resins such as LUCKAMIDE (manufactured by DIC Corporation); and polythiol resins such as QE-340M (manufactured by Toray Industries, Inc.). Of those, for example, a polyvinyl acetal-based resin having a polymerizable functional group, and a polyester polyol-based resin having a polymerizable functional group are preferred from the viewpoint of polymerizability.

The thickness of the undercoat layer is preferably 0.1 μm or more and 10 μm or less, more preferably 0.5 μm or more and 5 μm or less.

In the present disclosure, the content of the electron-transporting substance in the undercoat layer is preferably 42 mass % or more and 70 mass % or less with respect to the total mass of the composition. When the content is 42 mass % or more and 70 mass % or less, the mobility is high, and hence the suppression of a pattern memory is enhanced. When the content is less than 42 mass %, the effect of the present disclosure is not sufficiently obtained in some cases. When the content is more than 70 mass %, elution occurs in some cases, and electrophotographic characteristics are not sufficiently obtained in some cases.

<Photosensitive Layer>

The photosensitive layers of the electrophotographic photosensitive member are mainly classified into (1) a laminate type photosensitive layer and (2) a monolayer type photosensitive layer. (1) The laminate type photosensitive layer has a charge-generating layer containing a charge-generating substance and a charge-transporting layer containing a charge-transporting substance. (2) The monolayer type photosensitive layer has a photosensitive layer containing both a charge-generating substance and a charge-transporting substance.

(1) Laminate Type Photosensitive Layer

The laminate type photosensitive layer has the charge-generating layer and the charge-transporting layer.

(1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The average thickness of the charge-generating layer is preferably 0.1 μm or more and 1 μm or less, more preferably 0.15 μm or more and 0.4 μm or less.

The charge-generating layer may be formed by preparing a coating liquid for a charge-generating layer containing the above-mentioned materials and a solvent, forming a coating film thereof, and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The content of the charge-transporting substance in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. The polyester resin is particularly preferably a polyarylate resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the charge-transporting layer is preferably 5 μm or more and 50 μm or less, more preferably 8 μm or more and 40 μm or less, particularly preferably 10 μm or more and 30 μm or less.

The charge-transporting layer may be formed by preparing a coating liquid for a charge-transporting layer containing the above-mentioned materials and a solvent, forming a coating film thereof, and drying the coating film. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

(2) Monolayer Type Photosensitive Layer

The monolayer type photosensitive layer may be formed by preparing a coating liquid for a photosensitive layer containing the charge-generating substance, the charge-transporting substance, a resin, and a solvent, forming a coating film thereof, and drying the coating film. Examples of the charge-generating substance, the charge-transporting substance, and the resin are the same as those of the materials in the section “(1) Laminate Type Photosensitive Layer.”

<Protective Layer>

In the present disclosure, a protective layer may be arranged on the photosensitive layer. The arrangement of the protective layer can improve durability.

It is preferred that the protective layer contain electroconductive particles and/or a charge-transporting substance, and a resin.

Examples of the electroconductive particles include particles of metal oxides, such as titanium oxide, zinc oxide, tin oxide, and indium oxide.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protective layer may be formed as a cured film by polymerizing a composition containing a monomer having a polymerizable functional group. A reaction at that time is, for example, a thermal polymerization reaction, a photopolymerization reaction, or a radiation polymerization reaction. Examples of the polymerizable functional group of the monomer having a polymerizable functional group include an acryloyl group and a methacryloyl group. A material having a charge-transporting ability may be used as the monomer having a polymerizable functional group.

The protective layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the protective layer is preferably 0.5 μm or more and 10 μm or less, more preferably 1 μm or more and 7 μm or less.

The protective layer may be formed by preparing a coating liquid for a protective layer containing the above-mentioned materials and a solvent, forming a coating film thereof, and drying and/or curing the coating film. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

[Process Cartridge and Electrophotographic Apparatus]

A process cartridge of the present disclosure has a feature of integrally supporting the electrophotographic photosensitive member described in the foregoing, and at least one unit selected from the group consisting of: a charging unit; a developing unit; a transfer unit; and a cleaning unit, and being removably mounted onto the main body of an electrophotographic apparatus.

In addition, an electrophotographic apparatus of the present disclosure has a feature of including: the electrophotographic photosensitive member described in the foregoing; a charging unit; an exposing unit; a developing unit; and a transfer unit.

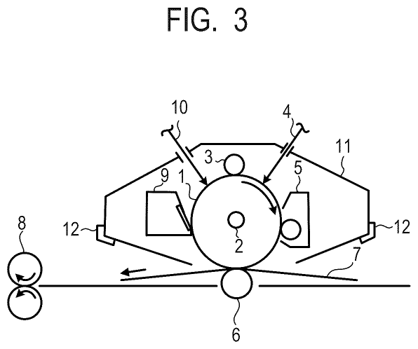

An example of the schematic configuration of an electrophotographic apparatus including the process cartridge including the electrophotographic photosensitive member is illustrated in FIG. 3.

An electrophotographic photosensitive member 1 of a cylindrical shape is rotationally driven about a shaft 2 in a direction indicated by the arrow at a predetermined peripheral speed. The surface of the electrophotographic photosensitive member 1 is charged to a positive or negative predetermined potential by a charging unit 3. Although a roller charging system based on a roller type charging member is illustrated in the figure, a charging system, such as a corona charging system, a contact charging system, or an injection charging system, may be adopted. The charged surface of the electrophotographic photosensitive member 1 is irradiated with exposure light 4 from an exposing unit (not shown), and thus an electrostatic latent image corresponding to target image information is formed thereon. The electrostatic latent image formed on the surface of the electrophotographic photosensitive member 1 is developed with a toner stored in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 onto which the toner image has been transferred is conveyed to a fixing unit 8, is subjected to treatment for fixing the toner image, and is printed out to the outside of the electrophotographic apparatus. The electrophotographic apparatus may include a cleaning unit 9 for removing a deposit such as the toner remaining on the surface of the electrophotographic photosensitive member 1 after the transfer. In addition, a so-called cleaner-less system configured to remove the deposit with the developing unit or the like without separate arrangement of the cleaning unit may be used. The electrophotographic apparatus may include an electricity-removing mechanism configured to subject the surface of the electrophotographic photosensitive member 1 to electricity-removing treatment with pre-exposure light 10 from a pre-exposing unit (not shown). In addition, a guiding unit 12 such as a rail may be arranged for removably mounting a process cartridge 11 of the present disclosure onto the main body of the electrophotographic apparatus.

The electrophotographic photosensitive member of the present disclosure may be used in, for example, a laser beam printer, an LED printer, a copying machine, a facsimile, and a multifunction machine thereof

[Production Method]

A method of producing the electrophotographic photosensitive member in the present disclosure includes a step of forming a coating film of a coating liquid for an undercoat layer, the coating liquid containing the electron-transporting substance represented by the formula (1) and a crosslinking agent, and a step of forming the undercoat layer by polymerizing the coating film. As a solvent to be used for the coating liquid, there are given an alcohol-based solvent, a ketone-based solvent, an ether-based solvent, an ester-based solvent, and an aromatic hydrocarbon-based solvent. In the step of forming the undercoat layer, the coating film is dried by heating to be polymerized, to thereby form the undercoat layer. A temperature at the time of the drying by heating is preferably a temperature of from 100° C. to 200° C.

According to the present disclosure, the electrophotographic photosensitive member capable of suppressing a pattern memory even in the case of high speed and high endurance can be provided.

### EXAMPLES

The present disclosure is described in more detail below by way of Examples and Comparative Examples. The present disclosure is by no means limited to the following Examples as long as its modifications do not deviate from the gist of the present disclosure. In the following description of Examples, the term “part(s)” is on a mass basis unless otherwise stated.

First, a synthesis example of the perylene imide compound (electron-transporting substance) represented by the formula (1) is described.

### Synthesis Example of Electron-Transporting Substance (A01)

Under a nitrogen atmosphere, 7.4 parts of 1,7-dibromo-3,4,9,10-perylenetetracarboxylic acid dianhydride (manufactured by Tokyo Chemical Industry Co., Ltd.) and 5.0 parts of L-(+)-leucinol (manufactured by Tokyo Chemical Industry Co., Ltd.) were added to 200 parts of dimethylacetamide, and the mixture was stirred at room temperature for 1 hour to prepare a solution. After having been prepared, the solution was refluxed for 8 hours, and the precipitate was separated by filtration and recrystallized with ethyl acetate to provide 10.0 parts of the electron-transporting substance (A01).

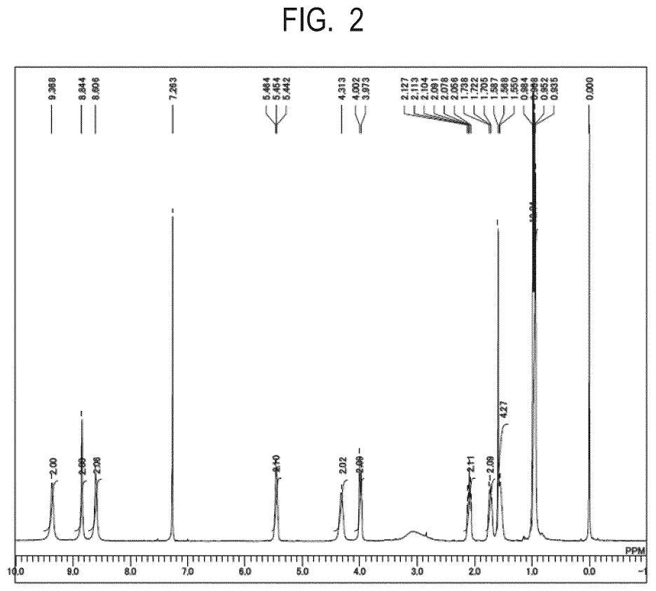

This compound was identified by NMR and verified to be the target product (FIG. 2).

The measurement of an NMR spectrum was performed under the following conditions.
Measurement apparatus used: JMN-EX400 (manufactured by JEOL Ltd.)
Solvent: deuterochloroform (CDCl₃)

### Example 1

### [Production of Electrophotographic Photosensitive Member]

### <Support>

An aluminum cylinder having a length of 260.5 mm and a diameter of 30 mm was prepared. The aluminum cylinder was subjected to cutting processing (JIS B 0601:2014, ten-point average roughness Rzjis: 0.8 μm), and the processed aluminum cylinder was used as a support (electroconductive support).

<Undercoat Layer>

Next, 3 parts of Exemplified Compound (A01) serving as an electron-transporting substance, 6.49 parts of a blocked isocyanate compound (product name: SBB-70P, solid content: 70%, isocyanate:blocking group=6.7:3.3 (mass ratio), manufactured by Asahi Kasei Corp.) serving as an isocyanate compound, and 0.40 part of a styrene-acrylic resin (product name: UC-3920, manufactured by Toagosei Co., Ltd.) serving as a resin were dissolved in a mixed solvent of 48 parts of 1-butanol and 24 parts of acetone. The resultant coating liquid for an undercoat layer was applied onto the support by dip coating, and the resultant coating film was heated at 170° C. for 40 minutes to be cured (polymerized), to thereby form an undercoat layer having a thickness of 1.5 μm.

<Charge-generating Layer>

Next, a hydroxygallium phthalocyanine crystal (charge-generating substance) of a crystal form having peaks at Bragg angles)(20±0.2° of 7.5°, 9.9°, 12.5°, 16.3°, 18.6°, and 28.3° in CuKα characteristic X-ray diffraction was prepared. 10 Parts of the hydroxygallium phthalocyanine crystal, 5 parts of a polyvinyl butyral resin (product name: S-LEC BX-1, manufactured by Sekisui Chemical Co., Ltd.), and 250 parts of cyclohexanone were loaded into a sand mill using glass beads each having a diameter of 1 mm, and were subjected to dispersion treatment for 2 hours. Next, 250 parts of ethyl acetate was added to the resultant to prepare a coating liquid for a charge-generating layer. The coating liquid for a charge-generating layer was applied onto the undercoat layer by dip coating to form a coating film, and the resultant coating film was dried at a temperature of 95° C. for 10 minutes to form a charge-generating layer having a thickness of 0.15 μm.

<Charge-Transporting Layer>

5 Parts of a charge-transporting substance represented by the following formula (B-1),

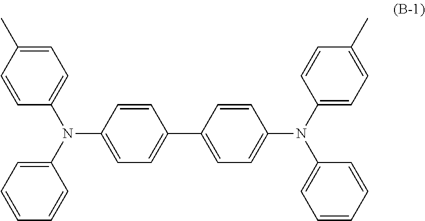 [SMILES: Cc1ccc(N(c2ccccc2)c2ccc(-c3ccc(N(c4ccccc4)c4ccc(C)cc4)cc3)cc2)cc1]

and 5 parts of a charge-transporting substance represented by the following formula (B-2),

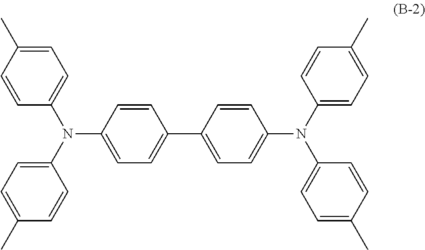 [SMILES: Cc1ccc(N(c2ccc(C)cc2)c2ccc(-c3ccc(N(c4ccc(C)cc4)c4ccc(C)cc4)cc3)cc2)cc1]

serving as charge-transporting substances, and 10 parts of polycarbonate (product name: IUPILON Z-400, manufactured by Mitsubishi Engineering-Plastics Corporation) were dissolved in a mixed solvent of 25 parts of orthoxylene, 25 parts of methyl benzoate, and 25 parts of dimethoxymethane to prepare a coating liquid for a charge-transporting layer.

The thus prepared coating liquid for a charge-transporting layer was applied onto the above-mentioned charge-generating layer by dip coating to form a coating film, and the coating film was dried by heating at a temperature of 120° C. for 30 minutes to form a charge-transporting layer having a thickness of 25

[Evaluation]

For the evaluation of a pattern memory, a laser beam printer manufactured by Hewlett-Packard Company (product name: Laser Jet Enterprise M609dn) was prepared, pre-exposure was omitted, and a process speed was changed to 200 mm/s.

The evaluation of a pattern memory was performed as described below. The produced electrophotographic photosensitive member was mounted onto the above-mentioned laser beam printer manufactured by Hewlett-Packard Company. The resultant was placed under a low-temperature and low-humidity (15° C./10% RH) environment, and an image having a vertical line pattern of 3 dots and 100 spaces was repeatedly and continuously output on 20 sheets, followed by the output of a solid black image and a halftone image. After that, an image having a print percentage of 3% was repeatedly and continuously output on 200,000 sheets, and in the same manner as in the initial stage, the image having a vertical line pattern of 3 dots and 100 spaces was repeatedly and continuously output on 20 sheets, followed by the output of the solid black image and the halftone image. Based on the visibility of vertical streaks resulting from a hysteresis of the above-mentioned vertical lines on each of those output images, the degree of occurrence of the pattern memory was ranked into five categories and shown in Table 3. A case with a more satisfactory pattern memory is given a higher-number rank. The “halftone image” is a one-dot knight-jump pattern halftone. In the present disclosure, cases of ranks 3 to 5 are each regarded as a case in which the effect of the present disclosure has been obtained.

TABLE 3

| | Rank of pattern memory | | | | |
|---|---|---|---|---|---|
| | 5 | 4 | 3 | 2 | 1 |
| Solid black | Invisible | Faintly | Faintly | Visible | Visible |
| image | | visible | visible | | |
| Halftone | Invisible | Invisible | Faintly | Faintly | Visible |
| image | | | visible | visible | |

The results are shown in Table 4.

### Examples 2 to 27

Electrophotographic photosensitive members were produced in the same manner as in Example 1 except for changing the electron-transporting substance in Example 1 to electron-transporting substances shown in Table 4, and were evaluated in the same manner. The results are shown in Table 4.

### Examples 28 to 32

Electrophotographic photosensitive members were produced in the same manner as in Example 1 except for changing the amount of the electron-transporting substance, the amount of the crosslinking agent, and the amount of the resin in Example 1 as shown in Table 4, and were evaluated in the same manner. The results are shown in Table 4.

### Example 33

An electrophotographic photosensitive member was produced in the same manner as in Example 1 except for changing the electron-transporting substance in Example 1 to an electron-transporting substance shown in Table 4, and changing the amount of the crosslinking agent and the amount of the resin as shown in Table 4, and was evaluated in the same manner. The results are shown in Table 4.

### Example 34

An electrophotographic photosensitive member was produced and evaluated in the same manner as in Example 1 except for preparing the coating liquid for an undercoat layer in Example 1 as described below. The results are shown in Table 4.

Coating Liquid for Undercoat Layer

6.8 Parts of the electron-transporting substance (A01), 1.4 parts of the following compound (C-1) serving as an amino compound,

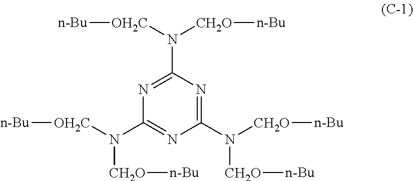

1.8 parts of a styrene-acrylic resin (product name: UC-3920, manufactured by Toagosei Co., Ltd.) serving as a resin, and 0.1 part of dodecylbenzenesulfonic acid serving as a catalyst were dissolved in a mixed solvent of 100 parts of dimethylacetamide and 100 parts of methyl ethyl ketone to prepare a coating liquid for an undercoat layer. The coating liquid for an undercoat layer was applied onto the support by dip coating, and the resultant coating film was dried by heating at 160° C. for 40 minutes to form an undercoat layer having a thickness of 1.50 μm.

The content of the electron-transporting substance with respect to the total mass of the composition containing the electron-transporting substance, the crosslinking agent, and the resin was 68 mass %.

### Examples 35 and 36

Electrophotographic photosensitive members were produced and evaluated in the same manner as in Example 34 except for changing the electron-transporting substance (A01) in Example 34 to the electron-transporting substance (A05) or (A21). The results are shown in Table 4.

### Example 37

A support and an electroconductive layer were produced as described below, and an undercoat layer, a charge-generating layer, and a charge-transporting layer similar to those in Example 1 were produced on the electroconductive layer, followed by evaluation. The results are shown in Table 4.

<Support>

An aluminum cylinder having a diameter of 30 mm and a length of 260.5 mm was used as a support (cylindrical support).

<Electroconductive Layer>

Anatase type titanium oxide having a primary particle diameter of 200 nm on average was used as a base, and a titanium-niobium sulfuric acid solution containing 33.7 parts of titanium in terms of TiO₂ and 2.9 parts of niobium in terms of Nb₂O₅ was prepared. 100 Parts of the base was dispersed in pure water to provide 1,000 parts of a suspension, and the suspension was warmed to 60° C. The titanium-niobium sulfuric acid solution and 10 mol/L sodium hydroxide were dropped into the suspension over 3 hours so that the suspension had a pH of from 2 to 3. After the total amount of the solutions had been dropped, the pH was adjusted to a value near a neutral region, and a polyacrylamide-based flocculant was added to the mixture to sediment a solid content. The supernatant was removed, and the residue was filtered and washed, followed by drying at 110° C. Thus, an intermediate containing 0.1 wt % of organic matter derived from the flocculant in terms of C was obtained. The intermediate was calcined in nitrogen at 750° C. for 1 hour, and was then calcined in air at 450° C. to produce titanium oxide particles. The resultant particles had an average particle diameter (average primary particle diameter) of 220 nm in the above-mentioned particle diameter measurement method using a scanning electron microscope.

Subsequently, 50 parts of a phenol resin (monomer/oligomer of a phenol resin) (product name: PLYOPHEN J-325, manufactured by DIC Corporation, resin solid content: 60%, density after curing: 1.3 g/cm²) serving as a binding material was dissolved in 35 parts of 1-methoxy-2-propanol serving as a solvent to provide a solution.

60 Parts of the titanium oxide particles 1 were added to the solution. The mixture was loaded into a vertical sand mill using 120 parts of glass beads having an average particle diameter of 1.0 mm as a dispersion medium, and was subjected to dispersion treatment under the conditions of a dispersion liquid temperature of 23±3° C. and a number of revolutions of 1,500 rpm (peripheral speed: 5.5 m/s) for 4 hours to provide a dispersion liquid. The glass beads were removed from the dispersion liquid with a mesh. 0.01 Part of a silicone oil (product name: SH28 PAINT ADDITIVE, manufactured by Dow Corning Toray Co., Ltd.) serving as a leveling agent and 8 parts of silicone resin particles (product name: KMP-590, manufactured by Shin-Etsu Chemical Co., Ltd., average particle diameter: 2 μm, density: 1.3 g/cm 3) serving as a surface roughness-imparting material were added to the dispersion liquid after the removal of the glass beads, and the mixture was stirred and filtered under pressure with PTFE filter paper (product name: PF060, manufactured by Advantec Toyo Kaisha, Ltd.) to prepare a coating liquid for an electroconductive layer.

The thus prepared coating liquid for an electroconductive layer was applied onto the above-mentioned support by dip coating to form a coating film, and the coating film was heated at 150° C. for 20 minutes to be cured, to thereby form an electroconductive layer having a thickness of 25 μm.

### Comparative Example 1

An electrophotographic photosensitive member was produced and evaluated in the same manner as in Example 30 except for changing the electron-transporting substance (A01) in Example 30 to an electron-transporting substance (D01). The results are shown in Table 4.

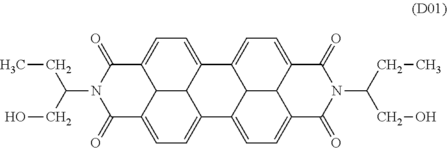 [SMILES: CCC(CO)N1C(=O)C2=CC=C3C4=CC=C5C(=O)N(C(CC)CO)C(=O)C6=CC=C(C7=CC=C(C1=O)C2C37)C4C56]

### Comparative Example 2

An electrophotographic photosensitive member was produced and evaluated in the same manner as in Example 30 except for changing the electron-transporting substance (A01) in Example 30 to an electron-transporting substance (D02). The results are shown in Table 4.

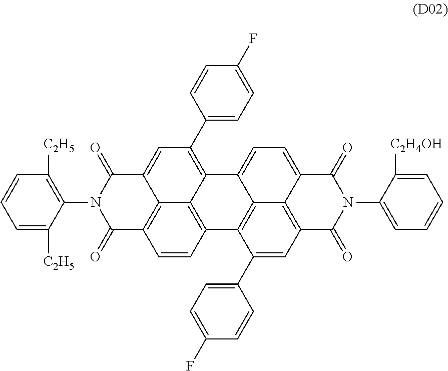

### Comparative Example 3

An electrophotographic photosensitive member was produced and evaluated in the same manner as in Example 30 except for changing the electron-transporting substance (A01) in Example 30 to an electron-transporting substance (D03). The results are shown in Table 4.

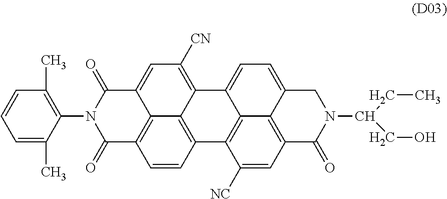 [SMILES: CCC(CO)N1Cc2ccc3c4c(C#N)cc5c6c(ccc(c7c(C#N)cc(c2c37)C1=O)c64)C(=O)N(c1c(C)cccc1C)C5=O]

TABLE 4

| | Undercoat layer | | | | | | |
|---|---|---|---|---|---|---|---|
| | | Amount of | | | Ratio of | | |
| | | electron- | Amount of | | charge- | | |
| | Electron- | transporting | crosslinking | Amount | transporting | Pattern memory | |
| | transporting | substance | agent | of resin | substance | | After |
| | substance | (part(s)) | (part(s)) | (part(s)) | (%) | Initial | endurance |
| Example 1 | A01 | 5.1 | 3 | 0.4 | 60 | 5 | 4 |
| Example 2 | A05 | 5.1 | 3 | 0.4 | 60 | 5 | 4 |
| Example 3 | A03 | 5.1 | 3 | 0.4 | 60 | 5 | 4 |
| Example 4 | A04 | 5.1 | 3 | 0.4 | 60 | 5 | 4 |
| Example 5 | A06 | 5.1 | 3 | 0.4 | 60 | 4 | 4 |
| Example 6 | A07 | 5.1 | 3 | 0.4 | 60 | 4 | 4 |
| Example 7 | A08 | 5.1 | 3 | 0.4 | 60 | 4 | 4 |
| Example 8 | A09 | 5.1 | 3 | 0.4 | 60 | 4 | 4 |
| Example 9 | A10 | 5.1 | 3 | 0.4 | 60 | 4 | 4 |
| Example 10 | A39 | 5.1 | 3 | 0.4 | 60 | 4 | 4 |
| Example 11 | A11 | 5.1 | 3 | 0.4 | 60 | 4 | 4 |
| Example 12 | A12 | 5.1 | 3 | 0.4 | 60 | 4 | 4 |
| Example 13 | A13 | 5.1 | 3 | 0.4 | 60 | 4 | 4 |
| Example 14 | A15 | 5.1 | 3 | 0.4 | 60 | 5 | 5 |
| Example 15 | A16 | 5.1 | 3 | 0.4 | 60 | 5 | 5 |
| Example 16 | A18 | 5.1 | 3 | 0.4 | 60 | 5 | 5 |
| Example 17 | A19 | 5.1 | 3 | 0.4 | 60 | 5 | 5 |
| Example 18 | A21 | 5.1 | 3 | 0.4 | 60 | 5 | 4 |
| Example 19 | A22 | 5.1 | 3 | 0.4 | 60 | 5 | 4 |
| Example 20 | A24 | 5.1 | 3 | 0.4 | 60 | 5 | 3 |
| Example 21 | A26 | 5.1 | 3 | 0.4 | 60 | 5 | 3 |
| Example 22 | A28 | 5.1 | 3 | 0.4 | 60 | 5 | 3 |
| Example 23 | A30 | 5.1 | 3 | 0.4 | 60 | 5 | 3 |
| Example 24 | A40 | 5.1 | 3 | 0.4 | 60 | 5 | 4 |
| Example 25 | A32 | 5.1 | 3 | 0.4 | 60 | 4 | 3 |
| Example 26 | A33 | 5.1 | 3 | 0.4 | 60 | 4 | 3 |
| Example 27 | A36 | 5.1 | 3 | 0.4 | 60 | 4 | 3 |
| Example 28 | A01 | 6.4 | 2.2 | 0.3 | 72 | 5 | 3 |
| Example 29 | A01 | 6.2 | 2.4 | 0.3 | 70 | 5 | 4 |
| Example 30 | A01 | 3.1 | 3.1 | 0.4 | 47 | 5 | 4 |
| Example 31 | A01 | 2.2 | 2.5 | 0.5 | 42 | 5 | 4 |
| Example 32 | A01 | 3.3 | 3.5 | 1.5 | 40 | 4 | 3 |
| Example 33 | A34 | 5.1 | 2.7 | 0 | 65 | 4 | 3 |
| Example 34 | A01 | 6.8 | 1.4 | 1.8 | 68 | 5 | 3 |
| Example 35 | A05 | 6.8 | 1.4 | 1.8 | 68 | 5 | 3 |
| Example 36 | A21 | 6.8 | 1.4 | 1.8 | 68 | 5 | 3 |
| Example 37 | A01 | 5.1 | 3 | 0.4 | 60 | 5 | 4 |
| Comparative | D01 | 3.1 | 3.1 | 0.4 | 47 | 3 | 1 |
| Example 1 | | | | | | | |
| Comparative | D02 | 3.1 | 3.1 | 0.4 | 47 | 4 | 1 |
| Example 2 | | | | | | | |
| Comparative | D03 | 3.1 | 3.1 | 0.4 | 47 | 4 | 2 |
| Example 3 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-096641, filed Jun. 15, 2022, which is hereby incorporated by reference herein in its entirety.

What is claimed is:

1. An electrophotographic photosensitive member comprising:
a support;
an undercoat layer formed on the support; and
a photosensitive layer formed on the undercoat layer,
wherein the undercoat layer contains a polymerization product of a composition containing: an electron-transporting substance represented by the following formula (1); and a crosslinking agent, and
wherein the crosslinking agent has a functional group capable of being bonded to at least one polymerizable functional group of the electron-transporting substance: 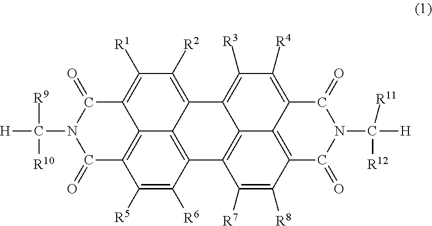
in the formula (1),
R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group, and
R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group,
provided that at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.

2. The electrophotographic photosensitive member according to claim 1, wherein, in the formula (1), at least one of R², R³, R⁶, or R⁷ represents a halogen atom or a substituted or unsubstituted alkyl group having 12 or less carbon atoms.

3. The electrophotographic photosensitive member according to claim 2, wherein, in the formula (1), R² and R⁷ are identical to each other.

4. The electrophotographic photosensitive member according to claim 1, wherein, in the formula (1), a group represented by —CHR⁹R¹⁰ is different from a group represented by —CHR¹¹R¹².

5. The electrophotographic photosensitive member according to claim 1, wherein, in the formula (1), R⁹ represents an alkyl group having a polymerizable functional group and having 2 or less carbon atoms.

6. The electrophotographic photosensitive member according to claim 1, wherein at least one of the polymerizable functional groups in the formula (1) is a hydroxy group.

7. The electrophotographic photosensitive member according to claim 1, wherein the crosslinking agent is one of: an isocyanate compound having one of an isocyanate group or a blocked isocyanate group; or an amine compound having one of an N-methylol group or an alkyl-etherified N-methylol group.

8. The electrophotographic photosensitive member according to claim 1, wherein a content of the electron-transporting substance represented by the formula (1) having the polymerizable functional group in the composition is 42 mass % or more and 70 mass % or less.

9. A method of producing an electrophotographic photosensitive member,
the electrophotographic photosensitive member including a support, an undercoat layer formed on the support, and a photosensitive layer formed on the undercoat layer,
the undercoat layer containing a polymerization product of a composition containing: an electron-transporting substance represented by the following formula (1); and a crosslinking agent,
the crosslinking agent having a functional group capable of being bonded to at least one polymerizable functional group of the electron-transporting substance,
the method comprising:
forming a coating film of a coating liquid for an undercoat layer, the coating liquid containing the electron-transporting substance represented by the following formula (1) and the crosslinking agent; and
forming the undercoat layer by polymerizing the coating film: 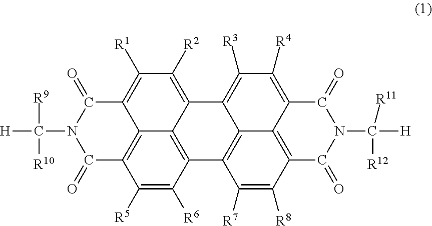
in the formula (1),
R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group, and
R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group,
provided that at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.

10. A process cartridge comprising:
an electrophotographic photosensitive member; and
at least one unit selected from the group consisting of: a charging unit; a developing unit; and a cleaning unit,
the process cartridge integrally supporting the electrophotographic photosensitive member and the at least one unit, and being removably mounted onto an electrophotographic apparatus,
wherein the electrophotographic photosensitive member includes a support, an undercoat layer formed on the support, and a photosensitive layer formed on the undercoat layer,
wherein the undercoat layer contains a polymerization product of a composition containing: an electron-transporting substance represented by the following formula (1); and a crosslinking agent, and
wherein the crosslinking agent has a functional group capable of being bonded to at least one polymerizable functional group of the electron-transporting substance: 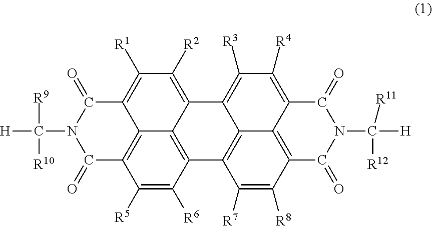
in the formula (1),
R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group, and
R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group,
provided that at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.

11. An electrophotographic apparatus comprising:
an electrophotographic photosensitive member;
a charging unit;
an exposing unit;
a developing unit; and
a transfer unit,
wherein the electrophotographic photosensitive member includes a support, an undercoat layer formed on the support, and a photosensitive layer formed on the undercoat layer,
wherein the undercoat layer contains a polymerization product of a composition containing: an electron-transporting substance represented by the following formula (1); and a crosslinking agent, and
the crosslinking agent has a functional group capable of being bonded to at least one polymerizable functional group of the electron-transporting substance: 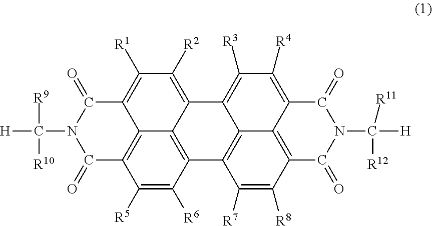
in the formula (1),
R¹ to R⁸ each independently represent a hydrogen atom, a cyano group, a nitro group, a halogen atom, an alkoxycarbonyl group, a substituted or unsubstituted alkyl group, or a substituted or unsubstituted aryl group, provided that at least one of R², R³, R⁶, or R⁷ represents a cyano group, a nitro group, a halogen atom, an alkoxycarbonyl group, a substituted or unsubstituted alkyl group, or a substituted or unsubstituted aryl group, and
R⁹ to R¹² each independently represent a polymerizable functional group, an unsubstituted alkyl group, an alkyl group substituted with a polymerizable functional group, an alkyl group substituted with a group other than a polymerizable functional group, an alkyl group substituted with a polymerizable functional group and a group other than the polymerizable functional group, an unsubstituted aryl group, an aryl group substituted with a polymerizable functional group, an aryl group substituted with a group other than a polymerizable functional group, or an aryl group substituted with a polymerizable functional group and a group other than the polymerizable functional group,
provided that at least one of R⁹ to R¹² represents a polymerizable functional group, an alkyl group substituted with a polymerizable functional group, an alkyl group substituted with a polymerizable functional group and a group other than the polymerizable functional group, an aryl group substituted with a polymerizable functional group, or an aryl group substituted with a polymerizable functional group and a group other than the polymerizable functional group.
